(19) United States
(12) Patent Application Publication
(10) Pub. No.: US 2016/0249413 A1
(43) Pub. Date: Aug. 25, 2016

(54) TRANSPARENT PLANAR HEATER

(71) Applicant: ELECTRONICS AND TELECOMMUNICATIONS RESEARCH INSTITUTE, Daejeon (KR)

(72) Inventors: JungWook LIM, Daejeon (KR); Sun Jin YUN, Daejeon (KR)

(73) Assignee: ELECTRONICS AND TELECOMMUNICATIONS RESEARCH INSTITUTE, Daejeon (KR)

(21) Appl. No.: 15/047,695

(22) Filed: Feb. 19, 2016

(30) Foreign Application Priority Data
Feb. 23, 2015 (KR) 10-2015-0025288
Dec. 14, 2015 (KR) 10-2015-0178462

(51) Int. Cl. H05B 3/26; H05B 6/54

(52) U.S. Cl. CPC H05B 3/26; H05B 6/54

(57) ABSTRACT

Provided is a transparent planar heater including a transparent substrate, a transparent heating layer disposed on the transparent substrate, and an electrode disposed on the transparent heating layer and electrically connected to the transparent heating layer. The transparent heating layer includes a metal layer disposed on the transparent substrate, the metal layer being configured to receive an external power from the electrode, thereby generating heat, and a selective transmission layer disposed on the transparent substrate to block at least a portion of a wavelength region of an infrared rays region of light and transmit a portion of the wavelength region of the light.

### CROSS-REFERENCE TO RELATED APPLICATIONS

This U.S. non-provisional patent application claims priority under 35 U.S.C. §119 to Korean Patent Application No. 10-2015-0025288, filed on Feb. 23, 2015, and 10-2015-0178462, filed on Dec. 14, 2015, the entire contents of which are hereby incorporated by reference.

### BACKGROUND

The inventive concepts relate to a transparent planar heater.

Since a planar heater generates heat by applying electricity, the planar heater does not generate air pollution, electromagnetic waves, noise, or the like and thus is used for various kinds of fields.

For example, the planar heater is used for a residential heating system for heating a floor of an apartment or a general house, an industrial heating system for an office or a working area, an industrial heating device for printing drying or painting drying, and a vehicle heating device for removing frost or moisture on a sunroof or window of a vehicle.

### SUMMARY

Embodiments of the inventive concepts provide a transparent planar heater that prevents infrared rays and the like and improves heating uniformity.

The object of the present invention is not limited to the aforesaid, but other objects not described herein will be clearly understood by those skilled in the art from descriptions below.

An embodiment of the inventive concept provides a transparent planar heater including: a transparent substrate; a transparent heating layer disposed on the transparent substrate; and an electrode disposed on the transparent heating layer and electrically connected to the transparent heating layer. The transparent heating layer includes: a metal layer disposed on the transparent substrate, the metal layer being configured to receive an external power from the electrode, thereby generating heat; and a selective transmission layer disposed on the transparent substrate to block at least a portion of a wavelength region of an infrared rays region of light and transmit a portion of the wavelength region of the light.

In an embodiment, the metal layer may include at least one of gold (Au), platinum (Pt), silver (Ag), aluminum (Al), copper (Cu), zinc (Zn), TiN, TaN, tungsten (W), titanium (Ti), molybdenum (Mo), and chrome (Cr).

In an embodiment, the selective transmission layer may transmit at least a portion of a wavelength region of a visible rays region.

In an embodiment, the selective transmission layer may include at least one of indium tin oxide (ITO), an aluminum-doped zinc oxide (ZnO:Al), a gallium doped zinc oxide (ZnO:Ga), a boron-doped zinc oxide (ZnO:B), a fluorine-doped tin dioxide (SnO₂:F), a tin dioxide (SnO2), InZnO, gold (Au), platinum (Pt), silver (Ag), aluminum (Al), molybdenum (Mo), and chrome (Cr).

In an embodiment, the transparent heating layer may further include a heat dissipation layer disposed on the metal layer and configured to uniformly release the heat generated from the metal layer.

In an embodiment, the heat dissipation layer may include at least one of gold (Au), platinum (Pt), silver (Ag), aluminum (Al), copper (Cu), zinc (Zn), nickel (Ni), TiN, TaN, tungsten (W), titanium (Ti), molybdenum (Mo), and chrome (Cr).

In an embodiment, the transparent heating layer may have a thickness of 10 nm to 200 nm.

In an embodiment, the transparent heating layer may further include a seed layer disposed between the transparent substrate and the metal layer.

In an embodiment, the transparent heating layer may further include a conductive oxide layer disposed between the metal layer and the electrode, and the metal layer may be disposed between the seed layer and the conductive oxide layer.

In an embodiment, the transparent planar heater may further include a transparent protective layer disposed on the transparent heating layer to cover the electrode.

In an embodiment, the transparent planar heater may further include a stress relaxation layer disposed below the transparent substrate to relax stress applied to the transparent substrate.

In an embodiment, the transparent heating layer has a pattern exposing a portion of the transparent substrate.

Particularities of other embodiments are included in the detailed description and drawings.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is an exploded perspective view of a transparent planar heater according to an embodiment of the inventive concept;

FIG. 2 is a cross-sectional view of the transparent planar heater of FIG. 1;

FIG. 3A is a graph illustrating resistance of a metal layer according to a thickness of the metal layer of FIG. 1;

FIG. 3B is a graph illustrating a transmittance of the metal layer according to the thickness of the metal layer of FIG. 1;

FIG. 4 is a graph illustrating a transmittance according to a wavelength of light transmitted through a selective transmission layer of FIG. 1;

FIG. 5 is a cross-sectional view of a transparent planar heater according to an embodiment of the inventive concept;

FIG. 6 is a view of the bent transparent planar heater of FIG. 1;

FIG. 7 is a perspective view illustrating a portion of constituents of a transparent planar heater according to an embodiment of the inventive concept; and

FIG. 8 is a plan view illustrating a portion of constituents of the transparent planar heater of FIG. 7.

### DETAILED DESCRIPTION

Advantages and features of the inventive concepts, and implementation methods thereof will be clarified through following embodiments described with reference to the accompanying drawings. The present invention may, however, be embodied in many different forms and should not be construed as being limited to the embodiments set forth herein. Rather, these embodiments are provided so that this disclosure will be thorough and complete, and will fully convey the concept of the invention to those skilled in the art. Further, the present invention is only defined by scopes of claims. Like reference numerals refer to like elements throughout.

In the following description, the technical terms are used only for explaining a specific exemplary embodiment while not limiting the present invention. The terms of a singular form may include plural forms unless referred to the contrary. The meaning of ‘comprises’ and/or ‘comprising’ specifies a component, a step, an operation and/or an element does not exclude other components, steps, operations and/or elements.

The object of the present invention is not limited to the aforesaid, but other objects not described herein will be clearly understood by those skilled in the art from descriptions below. Terms as defined in a commonly used dictionary should be construed as having the same meaning as in an associated technical context, and unless defined apparently in the description, the terms are not ideally or excessively construed as having formal meaning.

Hereinafter, a transparent planar heater according to exemplary embodiments of the inventive concept will be described in detail with reference to the accompanying drawings.

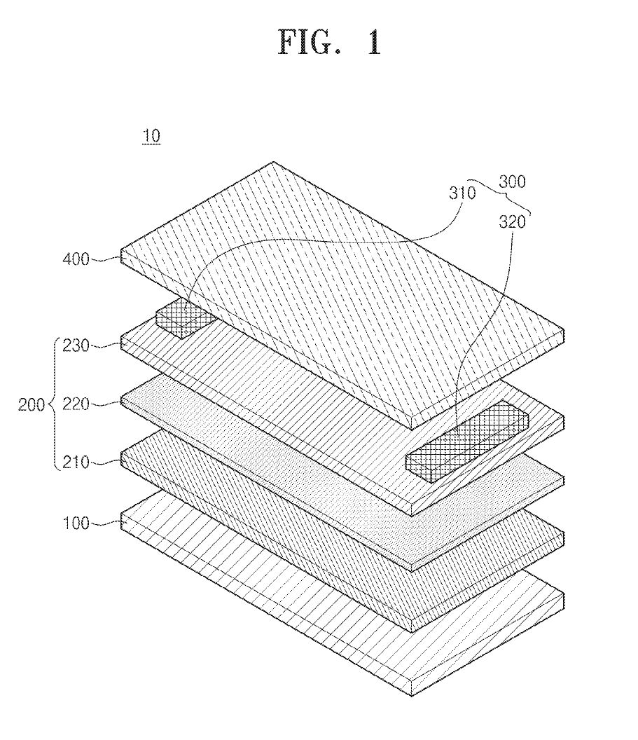

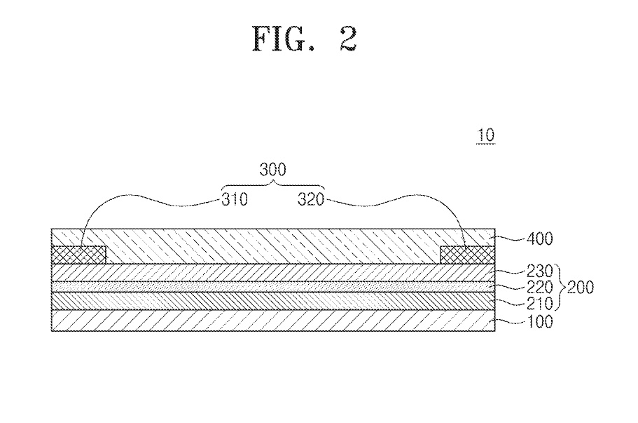

FIG. 1 is an exploded perspective view of a transparent planar heater according to an embodiment of the inventive concept. FIG. 2 is a cross-sectional view of the transparent planar heater of FIG. 1.

Referring to FIGS. 1 and 2, a transparent planar heater 10 according to an embodiment of the inventive concept may transmit light. The transparent planar heater 10 may generate heat. Accordingly, the transparent planar heater 10 may be used for moisture removal, heating, drying, and the like. For example, although the transparent planar heater 10 may be provided to various kinds of windows to remove frost and moisture generated in the windows, an embodiment of the inventive concept is not limited thereto.

Referring to FIG. 1, the transparent planar heater 10 may include a transparent substrate 100, a transparent heating layer 200, and an electrode 300. The transparent planar heater 10 may include a transparent protective layer 400. According to an embodiment of the inventive concept, the transparent planar heater 10 has a structure in which the transparent substrate 100, the transparent heating layer 200, the electrode 300, and the transparent protective layer 400 are sequentially laminated.

The transparent substrate 100 may be made of transparent glass or transparent plastic. Accordingly, light may be transmitted through the transparent substrate 100. The transparent substrate 100 may have a flat plate shape or a curved shape having a curvature.

According to an embodiment of the inventive concept, the transparent substrate 100 may be a flat plate shaped substrate made of a glass material. The transparent substrate 100 may include an alkali-free glass material, an alkali-silica-based glass material, and a quartz glass material. Also, a transparent oxide or amorphous silicon may be deposited on the transparent substrate 100.

The transparent substrate 100 may have a thickness of about 1 μm to about 10,000 μm. Here, the thickness may represent a vertical height of the transparent substrate 100.

The transparent heating layer 200 may be disposed on the substrate. The transparent heating layer 200 may transmit light. The transparent heating layer 200 may be electrically connected to the electrode 300. Accordingly, the transparent heating layer 200 may receive an external power from the electrode 300 to generate heat.

The transparent heating layer 200 may have a thickness of about 10 nm to about 500 nm The transparent heating layer 200 may include a metal layer 220, a selective transmission layer 230, and a seed layer 210. According to an embodiment of the inventive concept, the transparent heating layer 200 may have a structure in which the seed layer 210, the metal layer 220, and the selective transmission layer 230 are sequentially laminated.

The seed layer 210 may be disposed on the transparent substrate 100. The seed layer 210 may have a thickness of about 5 nm to about 200 nm The seed layer 210 may improve thin-film quality including crystallizability of the metal layer 220. Accordingly, the transparent planar heater 10 may be improved in electrical conductivity and optical transmittance.

The seed layer 210 may include at least one of indium tin oxide (ITO), an aluminum doped zinc oxide (ZnO:Al), a gallium doped zinc oxide (ZnO:Ga), a boron doped zinc oxide (ZnO:B), a zinc oxide containing tin (ZnsnO), a fluorine doped tin dioxide (SnO₂:F), a tin dioxide (SnO2), InZnO, a vanadium pentoxide (V₂O5), an aluminum oxide (Al₂O₃), a silicon dioxide (SiO₂), a titanium dioxide (TiO₂), AlTiO, ZnO. Accordingly, the seed layer 210 may prevent the metal layer 220 from being oxidized. The seed layer 210 may transmit light.

The seed layer 210 may be formed by one of evaporation, sputtering, chemical vapor deposition (CVD), atomic layer deposition (ALD), pulsed laser deposition (PLD), molecular beam epitaxy (MBE), sol-gel, spray, and printing.

The metal layer 220 may be disposed above the transparent substrate 100. Here, the disposition above the transparent substrate 100 may represent that the metal layer 220 contacts or is spaced apart from an upper portion of the transparent substrate 100. According to an embodiment of the inventive concept, the metal layer 220 may be spaced apart from the transparent substrate 100. The metal layer 220 may be disposed on the seed layer 210 disposed between the metal layer 220 and the transparent substrate 100.

The metal layer 220 may be electrically connected to the electrode 300 to receive an external power (not shown). When the metal layer 220 receives the external power, the metal layer 220 may generate heat. The metal layer 220 may have a large sized area.

The metal layer 220 may include at least one of gold (Au), platinum (Pt), silver (Ag), aluminum (Al), copper (Cu), zinc (Zn), TiN, TaN, tungsten (W), titanium (Ti), molybdenum (Mo), and chrome (Cr).

The metal layer 220 may be formed by one of evaporation, sputtering, chemical vapor deposition (CVD), atomic layer deposition (ALD), pulsed laser deposition (PLD), molecular beam epitaxy (MBE), sol-gel, spray, and printing.

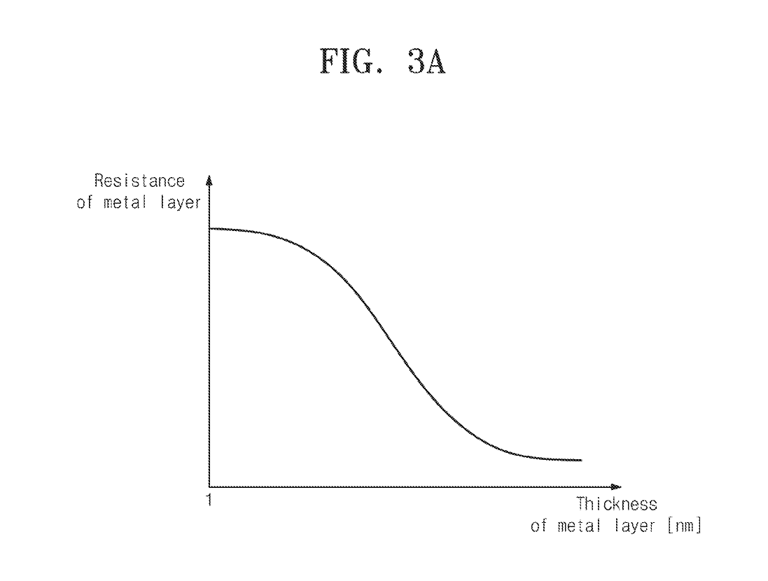

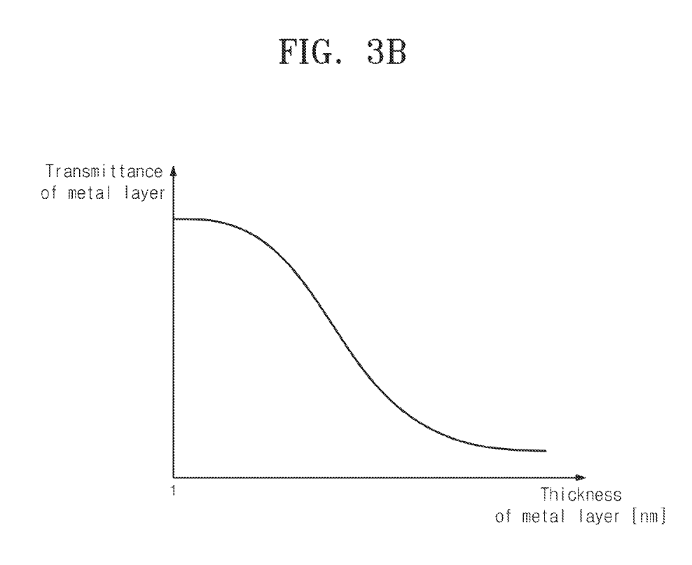

The metal layer 220 may use nano-level particles to improve heating characteristics and transparency. The metal layer 220 may have a flat plate shape having a thickness of about 1 nm to about 50 nm The transparent planar heater 10 may adjust the thickness of the metal layer 220 to control a heating amount. This will be described in detail in FIG. 3A.

The selective transmission layer 230 may be disposed above the transparent substrate 100. According to an embodiment of the inventive concept, the selective transmission layer 230 may be spaced apart from an upper portion of the transparent substrate 100. The selective transmission layer 230 may be disposed on the metal layer 220 disposed between the transparent substrate 100 and the selective transmission layer 230. Alternatively, according to another embodiment, the selective transmission layer 230 may be disposed between the seed layer 210 and the metal layer 220.

The selective transmission layer 230 may include at least one of indium tin oxide (ITO), an aluminum doped zinc oxide (ZnO:Al), a gallium doped zinc oxide (ZnO:Ga), a boron doped zinc oxide (ZnO:B), a fluorine doped tin dioxide (SaO₂:F), a tin dioxide (SnO2), InZnO, gold (Au), platinum (Pt), silver (Ag), aluminum (Al), molybdenum (Mo), and chrome (Cr).

The selective transmission layer 230 may have a thickness of about 5 nm to about 300 nm. When the selective transmission layer 230 increases in thickness, resistance of the selective transmission layer 230 with respect to current flowing from the electrode 300 to the metal layer 220 may increase.

For example, when the thickness of the selective transmission layer 230 increases, a migration distance of the current flowing from the electrode 300 to the metal layer 220 may increase. As the migration distance of the current increases, the resistance of the selective transmission layer 230 may increase. Accordingly, the thickness of the selective transmission layer 230 may be adjusted within a range of about 5 nm to about 300 nm in consideration of resistance, purpose of usage, and process variables.

The selective transmission layer 230 may be formed by one of evaporation, sputtering, chemical vapor deposition (CVD), atomic layer deposition (ALD), pulsed laser deposition (PLD), molecular beam epitaxy, sol-gel, spray, and printing.

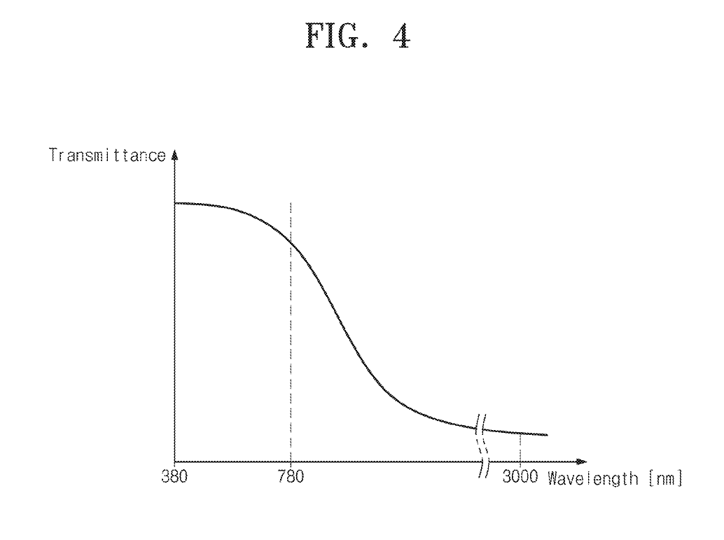

The selective transmission layer 230 may block a portion of light and transmit a portion of light. This will be described in detail later in FIG. 4.

The electrode 300 may be disposed on the transparent heating layer 200. The electrode 300 may be connected to an external power through a wire (not shown). The electrode 300 may be electrically connected to the transparent heating layer 200 and provide the external power to the transparent heating layer 200.

The electrode 300 may be a transparent conductive material. The electrode 300 may include a first electrode 310 disposed on one side of the transparent heating layer 200 and a second electrode 320 disposed on the other side of the transparent heating layer 200.

The electrode 300 may include at least one of indium tin oxide (ITO), an aluminum doped zinc oxide (ZnO:Al), a gallium doped zinc oxide (ZnO:Ga), a boron doped zinc oxide (ZnO:B), a fluorine doped tin dioxide (SaO₂:F), a tin dioxide (SnO2), InZnO, gold (Au), platinum (Pt), silver (Ag), aluminum (Al), copper (Cu), zinc (Zn), TiN, TaN, tungsten (W), titanium (Ti), molybdenum (Mo), and chrome (Cr).

The transparent protective layer 400 may be disposed on the transparent heating layer 200. The transparent protective layer 400 may cover the electrode 300 disposed on the transparent heating layer 200. Accordingly, the transparent protective layer 400 may protect the transparent heating layer 200 and the electrode 300 against external shock or a chemical material. Also, the transparent protective layer 400 may have insulation effects.

The transparent protective layer 400 may include a insulation material having excellent heat transfer and heat capacity characteristics. For example, the transparent protective layer 400 may include at least one of an aluminum oxide (Al₂O₃), a silicon dioxide (SiO₂), a titanium dioxide (TiO₂), AlTiO, a zinc oxide (ZnO), a vanadium pentoxide (V₂O5), a zirconium dioxide (ZrO₂), and a hafnium dioxide (HfO₂).

The transparent protective layer 400 may be formed by one of evaporation, sputtering, chemical vapor deposition (CVD), atomic layer deposition (ALD), pulsed laser deposition (PLD), molecular beam epitaxy (MBE), sol-gel, spray, and printing.

FIG. 3A is a graph illustrating resistance of the metal layer according to the thickness of the metal layer. FIG. 3B is a graph illustrating a transmittance of the metal layer according to the thickness of the metal layer.

Referring to FIGS. 3A and 3B, according to an embodiment of the inventive concept, when the thickness of the metal layer (see reference numeral 220 in FIG. 2) increases, resistance with respect to current flowing to the metal layer 220 may decrease. That is, the resistance of the metal layer 220 is inversely proportional to the thickness of the metal layer 220.

For example, when a voltage applied to the metal layer 220 is constant, a heating value of the metal layer 220 is inversely proportional to the resistance. Since the resistance of the metal layer 220 is inversely proportionally to the thickness of the metal layer 220, the heating value of the metal layer 220 may be proportional to the thickness of the metal layer 220. Thus, the heating value that is desirable to the transparent planar heater 10 may be realized through adjusting the thickness of the metal layer 220. The reason is that the resistance of the metal layer 220 is adjusted by adjusting the thickness of the metal layer 220.

Referring to FIG. 3B, as the metal layer 220 increases in thickness, the metal layer 220 decreases in transmittance. That is, the transmittance of the metal layer 220 is inversely proportional to the thickness of the metal layer 220.

When the thickness of the metal layer 220 increases, the transmittance and resistance of the metal layer 220 may decrease and the heating value of the metal layer 220 may increase. Accordingly, the thickness of the metal layer 220 may be adjusted within a range of about 1 nm to about 50 nm in consideration of a transmittance, resistance, purpose of usage, and process variables.

FIG. 4 is a graph illustrating a transmittance according to a wavelength of light transmitted through the selective transmission layer of FIG. 1.

As described above, the selective transmission layer (see reference numeral 230 in FIG. 2) may block a portion of light and transmit a portion of light. That is, the selective transmission layer 230 may block a predetermined wavelength region of the light and transmit the rest wavelength region of the light.

For example, the light transmitted through the selective transmission layer 230 may be reflected by a light incident surface (not shown) and a light emitting surface (not shown). Accordingly, the light transmitted through the selective transmission layer 230 may be interfered with the light reflected by the selective transmission layer 230. Since interference phenomenon of a light occurs, the light in a predetermined wavelength region may be blocked by the selective transmission layer 230, and the light in the rest wavelength region may be transmitted through the selective transmission layer 230.

Referring to FIG. 4, according to an embodiment of the inventive concept, the selective transmission layer 230 may decrease in transmittance as a wavelength of light increases. In detail, according to an embodiment of the inventive concept, the selective transmission layer 230 may block at least a portion of the wavelength region of an infrared rays region of the incident light. Accordingly, the selective transmission layer 230 may block infrared rays or control a transmission amount of the infrared rays. Here, the infrared rays region may include a wavelength range of about 780 nm to about 3 mm. Accordingly, the transparent planar heater (see reference numeral 10 in FIG. 1) may have heat insulation effects that efficiently prevent infrared rays.

In general, the infrared rays is a kind of electromagnetic waves having a wavelength greater than that of red visible rays. The infrared rays may have thermal action greater than that of visible rays or ultraviolet rays. Also, the heater may transmit radiant heat in a form of infrared rays.

The selective transmission layer 230 may block at least a portion of a wavelength region of the infrared rays of light to prevent the radiant heat generated from an inner space of the transparent planar heater (see reference numeral 10 in FIG. 2) from being released to the outside of the transparent planar heater 10. Also, the selective transmission layer 230 may prevent the radiant heat generated in an outer space of the transparent planar heater 10 from being introduced into the inner space of the transparent planar heater 10. Accordingly, the selective transmission layer 230 may serve as an heat-insulating material.

The selective transmission layer 230 may transmit at least a portion of a wavelength region of the visible rays region. Here, the visible rays region may include a wavelength range of about 380 nm to about 780 nm.

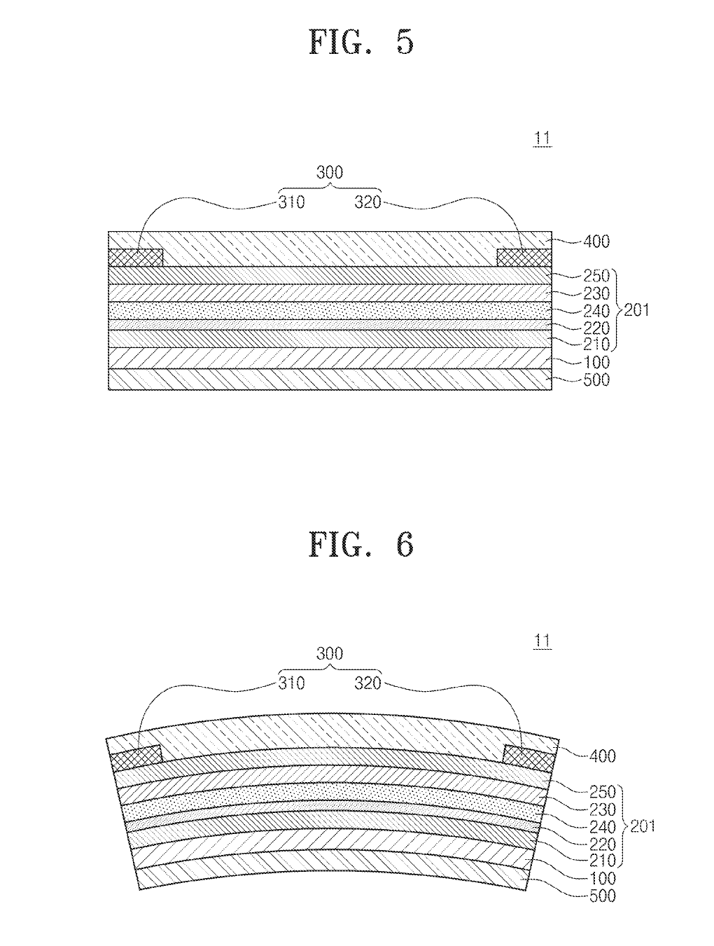

FIG. 5 is a cross-sectional view of a transparent planar heater according to an embodiment of the inventive concept. FIG. 6 is a view of the bent transparent planar heater of FIG. 1.

For simplicity of explanation, components that are substantially the same as the example described with reference to FIGS. 1 to 4 will not be provided.

Referring to FIGS. 5 and 6, according to an embodiment of the inventive concept, a transparent planar heater 11 may include a transparent substrate 100, a transparent heating layer 201, an electrode 300, a transparent protective layer 400, and a stress relaxation layer 500.

The transparent planar heater 11 may include a flexible or curved substrate. The transparent heating layer 201 may have a thickness of about 10 nm to about 200 nm. Since the transparent heating layer 201 has a small thickness of about 10 nm to about 200 nm, the transparent heating layer 201 may be flexibly bent or disposed on the curved transparent substrate 100. According to an embodiment of the inventive concept, the transparent planar layer 201 may have a thickness of about 150 nm.

The transparent planar heater 201 may include a seed layer 210, a metal layer 220, a heat dissipation layer 240, a selective transmission layer 230, and a conductive oxide layer 250.

The conductive oxide layer 250 may be disposed on the selective transmission layer 230. The conductive oxide layer 250 may prevent the metal layer 220 from being oxidized together with the seed layer 210. For example, the metal layer 220 may be disposed between the seed layer 210 and the conductive oxide layer 250 to prevent the metal layer 220 from being oxidized.

The conductive oxide layer 250 may include at least one of indium tin oxide (ITO), an aluminum doped zinc oxide (ZnO:Al), a gallium doped zinc oxide (ZnO:Ga), a boron doped zinc oxide (ZnO:B), a fluorine doped tin dioxide (SnO₂:F), a tin dioxide (SnO2), InZnO, a vanadium pentoxide (V₂O5), an aluminum oxide (Al₂O₃), a silicon dioxide (SiO₂), a titanium dioxide (TiO₂), and AlTiO.

The conductive oxide layer 250 may be formed by one of evaporation, sputtering, chemical vapor deposition (CVD), atomic layer deposition (ALD), pulsed laser deposition (PLD), molecular beam epitaxy (MBE), sol-gel, spray, and printing.

The metal layer 220 may be disposed between the seed layer 210 and the conductive oxide layer 250. The metal layer 220 may have a large sized area. Also, the electrodes 300 providing a power to the metal layer 220 may be disposed on both ends of the metal layer 220, respectively. Accordingly, the metal layer 220 having a large sized area may have heating amounts that are different between a middle portion and the both end portions thereof.

Also, the metal layer 220 may have an uneven top surface. That is, the top surface of the metal layer 220 may have an uneven portion (not shown) upwardly protruding. An area on which the uneven portion is disposed may have a thickness that is greater than that of an area on which the uneven portion is not disposed. Accordingly, the area on which the uneven portion is disposed may have a heating value that is greater than that of the area on which the uneven portion is not disposed. The heat dissipation layer 240 may be disposed on the metal layer 220. For example, the heat dissipation layer 240 may have a bottom surface contacting the metal layer 220 to absorb heat and a top surface releasing the absorbed heat in an upward direction.

The heat dissipation layer 240 may have an area corresponding to that of the metal layer 220. The heat dissipation layer 240 may absorb heat generated from the metal layer 220 to uniformly radiate the heat. Accordingly, the transparent planar heater 11 having a large sized area may uniformly generate heat in an almost entire area thereof.

The heat dissipation layer 240 may have a thickness of about 1 nm to about 20 nm. When the heat dissipation layer 240 increases in thickness, heating uniformity of the transparent planar heater 11 may be improved.

For example, while heat absorbed to the bottom surface of the heat dissipation layer 240 is upwardly transferred, the absorbed heat may be thermally conducted to the entire area of the heat dissipation layer 240. When the thickness of the heat dissipation layer 240 increases, a time in which the heat absorbed to the heat dissipation layer 240 is thermally conducted to the entire area of the heat dissipation layer 240 may increase. Accordingly, when the thickness of the heat dissipation layer 240 increases, the heating uniformity of the transparent planar heater 11 may be improved.

Also, when the thickness of the heat dissipation layer 240 increases, a migration distance of current flowing from the electrode 300 to the metal layer 220 may increase. As the migration distance of current increases, resistance between the electrode 300 and the metal layer 220 may increase. Thus, the thickness of the heat dissipation layer 240 may be adjusted in a range of about 1 nm to about 20 nm in consideration of resistance, heating uniformity efficiency, purpose of usage, and process variables.

The heat dissipation layer 240 may include at least one of gold (Au), platinum (Pt), silver (Ag), aluminum (Al), copper (Cu), zinc (Zn), nickel (Ni), TiN, TaN, tungsten (W), titanium (Ti), molybdenum (Mo), and chrome (Cr).

The heat dissipation layer 240 may be formed by one of evaporation, sputtering, chemical vapor deposition (CVD), atomic layer deposition (ALD), pulsed laser deposition (PLD), molecular beam epitaxy (MBE), sol-gel, spray, and printing.

The stress relaxation layer 500 may be disposed below the transparent substrate 100. The stress relaxation layer 500 may include a transparent material. For example, the stress relaxation layer 500 may include at least one of indium tin oxide (ITO), an aluminum doped zinc oxide (ZnO:Al), a gallium doped zinc oxide (ZnO:Ga), a boron doped zinc oxide (ZnO:B), a fluorine doped tin dioxide (SnO₂:F), a tin dioxide (SnO2), InZnO, a vanadium pentoxide (V₂O5), an aluminum oxide (Al₂O₃), a silicon dioxide (SiO₂), a titanium dioxide (TiO₂), and AlTiO.

The stress relaxation layer 500 may have a thickness of about 10 nm to about 500 nm. The stress relaxation layer 500 may be formed by one of evaporation, sputtering, chemical vapor deposition (CVD), atomic layer deposition (ALD), sol-gel, spray, and printing.

Referring to FIG. 6, when the transparent substrate is bent by an external force, stress may be generated in the transparent substrate 100. When great stress is applied to the transparent substrate 100, the transparent substrate 100 may be damaged. The stress relaxation layer 500 may absorb the stress applied to the transparent substrate 100.

For example, when a force is applied in a downward direction to both ends of the transparent substrate 100, a moment acts on the both ends of the transparent substrate 100. Accordingly, the stress is applied to the both ends of the transparent substrate 100 to deform the transparent substrate 100. At least a portion of the stress applied to the both ends of the transparent substrate 100 may be absorbed through the stress relaxation layer 500. The stress relaxation layer 500 may absorb the stress generated in the transparent substrate 100 to prevent or reduce the damage of the transparent substrate 100.

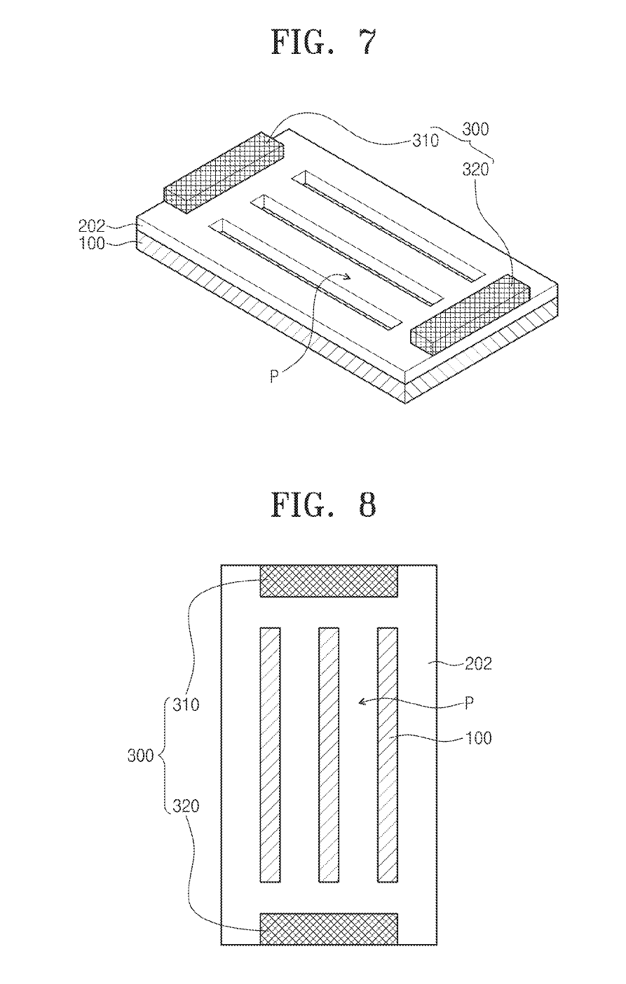

FIG. 7 is a perspective view illustrating a portion of constituents of a transparent planar heater according to an embodiment of the inventive concept. FIG. 8 is a plan view illustrating a portion of constituents of the transparent planar heater of FIG. 7.

For simplicity of description, description for components that are substantially the same as those of the embodiment that was described with reference to FIGS. 1 and 6 will not be provided.

Referring to FIGS. 7 and 8, according to an embodiment of the inventive concept, a transparent heating layer 202 may include a pattern P exposing a portion of the transparent substrate 100.

Although the transparent heating layer 202 includes a stripe pattern P, an embodiment of the inventive concept is not limited thereto. For example the transparent heating layer 202 may include various kinds of patterns such as a wave pattern, a zigzag pattern, a circular pattern, a diamond pattern, and a grid pattern. Thus, the transparent planar heater 12 may generate heat only on a portion in which the pattern is disposed.

The transparent planar heater according to the embodiment of the inventive concept has at least one of the following effects.

Infrared rays and/or ultraviolet rays may be prevented. When the transparent planar heater has a large sized area, the degradation in the uniformity of the generated heat may be prevented. Also, the transparent planar heater may be used for various purposes because it is transparent.

The object of the present invention is not limited to the aforesaid, but other objects not described herein will be clearly understood by those skilled in the art from descriptions below.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A transparent planar heater comprising:
a transparent substrate;
a transparent heating layer disposed on the transparent substrate; and
an electrode disposed on the transparent heating layer and electrically connected to the transparent heating layer,
wherein the transparent heating layer comprises:
a metal layer disposed on the transparent substrate, the metal layer being configured to receive an external power from the electrode, thereby generating heat; and
a selective transmission layer disposed on the transparent substrate to block at least a portion of a wavelength region of an infrared rays region of light and transmit a portion of the wavelength region of the light.

2. The transparent planar heater of claim 1, wherein the metal layer comprises at least one of gold (Au), platinum (Pt), silver (Ag), aluminum (Al), copper (Cu), zinc (Zn), TiN, TaN, tungsten (W), titanium (Ti), molybdenum (Mo), and chrome (Cr).

3. The transparent planar heater of claim 1, wherein the selective transmission layer transmits at least a portion of a wavelength region of a visible rays region.

4. The transparent planar heater of claim 1, wherein the selective transmission layer comprises at least one of indium tin oxide (ITO), an aluminum-doped zinc oxide (ZnO:Al), a gallium doped zinc oxide (ZnO:Ga), a boron-doped zinc oxide (ZnO:B), a fluorine-doped tin dioxide (SnO₂:F), a tin dioxide (SnO2), InZnO, gold (Au), platinum (Pt), silver (Ag), aluminum (Al), molybdenum (Mo), and chrome (Cr).

5. The transparent planar heater of claim 1, wherein the transparent heating layer further comprises a heat dissipation layer disposed on the metal layer and configured to uniformly release the heat generated from the metal layer.

6. The transparent planar heater of claim 5, wherein the heat dissipation layer comprises at least one of gold (Au), platinum (Pt), silver (Ag), aluminum (Al), copper (Cu), zinc (Zn), nickel (Ni), TiN, TaN, tungsten (W), titanium (Ti), molybdenum (Mo), and chrome (Cr).

7. The transparent planar heater of claim 1, wherein the transparent heating layer has a thickness of about 10 nm to about 200 nm.

8. The transparent planar heater of claim 1, wherein the transparent heating layer further comprises a seed layer disposed between the transparent substrate and the metal layer.

9. The transparent planar heater of claim 8, wherein the transparent heating layer further comprises a conductive oxide layer disposed between the metal layer and the electrode, and
the metal layer is disposed between the seed layer and the conductive oxide layer.

10. The transparent planar heater of claim 1, further comprising a transparent protective layer disposed on the transparent heating layer to cover the electrode.

11. The transparent planar heater of claim 1, further comprising a stress relaxation layer disposed below the transparent substrate to relax stress applied to the transparent substrate.

12. The transparent planar heater of claim 1, wherein the transparent heating layer has a pattern exposing a portion of the transparent substrate.
